(19) United States
(12) Patent Application Publication
(10) Pub. No.: US 2026/0190186 A1
(43) Pub. Date: Jul. 2, 2026

(54) HEATING MEANS USING CONDUCTIVE NANO FIBER-BASED PLANAR HEATING FILM

(71) Applicant: Nano Electronics Inc., Daejeon (KR)

(72) Inventor: Young Tae KIM, Daejeon (KR)

(21) Appl. No.: 19/065,721

(22) Filed: Feb. 27, 2025

(30) Foreign Application Priority Data
Dec. 31, 2024 (KR) 10-2024-0202628

(51) Int. Cl. H05B 3/58

(52) U.S. Cl. CPC H05B 3/58; H05B 2203/013; H05B 2203/024

(57) ABSTRACT

Provided is a heating means using a conductive nanofiber-based planar heating film. The heating means using a conductive nanofiber-based planar heating film includes a planar heating film made of conductive nanofibers, a plurality of path forming members attached to a first surface of the planar heating film at predefined positions along a longitudinal direction of the planar heating film, and a power supply part that supplies power to the planar heating film. The planar heating film forms a space through which air passes in a state of being spirally rolled along the longitudinal direction. The plurality of path forming members support the first surface and a second surfaces adjacent to each other by coming into contact with the second surface of the planar heating film in a state where the planar heating film is spirally rolled, and form a path for air introduced from one side of the planar heating film in the width direction and discharged to another side of the planar heating film in the width direction.

### CROSS-REFERENCE TO RELATED APPLICATION

This application is based on and claims priority under 35 U.S.C. § 119 to Korean Patent Application No. 10-2024-0202628, filed on Dec. 31, 2024, in the Korean Intellectual Property Office, the disclosure of which is incorporated by reference herein in its entirety.

### BACKGROUND

### 1. Field

The present disclosure relates to a heating means using a conductive nanofiber-based planar heating film, and more particularly, to a heating means using a conductive nanofiber-based planar heating film, which is capable of shortening an air heating time by improving heat transfer efficiency for air with a simpler structure.

### 2. Description of the Related Art

In general, a heating device is a device that generates high-temperature air by heating air using various types of heating means (heating elements), and is widely used in various industrial fields, such as air conditioning and heating devices, drying devices, or heat treatment devices.

A heating means for generating high-temperature air includes a heating wire that generates resistive heat by passing electric current through a metallic wire, a burner that generates heat by burning fuel, an infrared heater that directly heats an object by emitting infrared light, or the like. However, recently, a planar heating element that may efficiently heat a large area due to a fast thermal reaction speed and an uniform heat distribution and may allow for a lightweight and ultra-thin design has been mainly used.

For example, Korean Patent Publication No. 10-2006-0014485 (Drying Device Using Planar Heating Element) (published on Feb. 16, 2006), Korean Patent Publication No. 10-2009-0093082 (Electric Instantaneous Water Heater Having Flexible Planar Heating Element) (published on Sep. 2, 2009), and Korean Patent Registration No. 10-2062351 (Movable Timber Drying Device Having Planar Heating Element And Drying Method Thereof) (published on Feb. 11, 2020) disclose a structure of a heating device using a planar heating element having a thin film shape.

However, since a heating means using a conventional planar heating element has a structure in which a plurality of planar heating elements are arranged to surround an object to be heated and air around the object is heated to a desired temperature, the overall structure is complicated and occupies a lot of space and heat transfer efficiency is low. Accordingly, the time required to heat up to a desired temperature increases, and this leads to high power consumption.

Furthermore, a conventional planar heating element, such as a carbon nanotube planar heating element, a metal thin film planar heating element, or a ceramic planar heating element, has a problem that a manufacturing process thereof is complicated, which increases manufacturing costs, and has a problem that is vulnerable to external impact or damage.

Therefore, there is required a heating means using a conductive nanofiber-based planar heating film, which is capable of shortening an air heating time by improving heat transfer efficiency for air with a simpler structure.

### Prior Art Documents

Patent Document 1: Korean Patent Publication No. 10-2006-0014485 (Drying Device Using Planar Heating Element) (published on Feb. 16, 2006)

Patent Document 2: Korean Patent Publication No. 10-2009-0093082 (Electric Instantaneous Water Heater Having Flexible Planar Heating Element) (published on Sep. 2, 2009)

Patent Document 3: Korean Patent Registration No. 10-2062351 (Movable Timber Drying Device Having Planar Heating Element And Drying Method Thereof) (published on Feb. 11, 2020)

### SUMMARY

The present disclosure has been made in an effort to solve the problems described above, and an objective of the present disclosure is to provide a heating means using a conductive nanofiber-based planar heating film, in which a planar heating film is spirally rolled to form a space through which air passes, and a plurality of path forming members attached to a first surface of the planar heating film are configured to form an air path while supporting the adjacent first and second surfaces of the spirally rolled planar heating film, so that heat transfer efficiency for air may be improved without disturbing an air flow with a more simplified and miniaturized structure, and thus, an air heating time to a desired temperature may be significantly shortened.

The objectives of the present disclosure are not limited to those described above, and other objectives that are not disclosed herein will be clearly understood from the following description by those of ordinary skill in the art.

To achieve the objectives, a heating means using a conductive nanofiber-based planar heating film according to an embodiment of the present disclosure includes a planar heating film made of conductive nanofibers, a plurality of path forming members attached to a first surface of the planar heating film at predefined positions along a longitudinal direction of the planar heating film, and a power supply part that supplies power to the planar heating film, wherein the planar heating film forms a space through which air passes in a state of being spirally rolled along the longitudinal direction, and the plurality of path forming members support the first surface and a second surfaces adjacent to each other by coming into contact with the second surface of the planar heating film in a state where the planar heating film is spirally rolled, and form a path for air introduced from one side of the planar heating film in the width direction and discharged to another side of the planar heating film in the width direction.

As an example, the planar heating film includes a heating film formed as at least one layer in which a plurality of nanofibers coated with a conductive metal are arranged in series and/or in parallel, and an electrode part provided on both sides of the heating film and applying electric current supplied from the power supply part to the heating film.

As another example, the planar heating film includes a heating film formed by at least one layer in which a plurality of nanofibers are arranged in series and/or in parallel on a carbon ink layer applied to one surface of a polyethylene terephthalate (PET) film, and an electrode part provided on both sides of the heating film and applying electric current supplied from the power supply part to the heating film.

In this case, the planar heating film further includes a coating part formed on both surfaces of the heating film and coated by a laminating method.

In addition, the planar heating film has a truncated conical shape that is spirally rolled so that an area of another side through which air is discharged is narrower than an area of one side into which air is introduced.

As an example, each of the plurality of path forming members is formed of a metallic wire formed to be long along a width direction of the planar heating film.

As another example, each of the plurality of path forming members is formed of a metallic wire formed to be long and inclined along a width direction of the planar heating film.

As another example, each of the plurality of path forming members is formed of a metallic wire formed to be long in a spiral shape along a width direction of the planar heating film.

Specific details of other embodiments are included in the detailed description and drawings.

### BRIEF DESCRIPTION OF THE DRAWINGS

FIG. 1 is a perspective view schematically illustrating a structure of a heating means using a conductive nanofiber-based planar heating film according to an embodiment of the present disclosure.

FIG. 2 is a front view schematically illustrating the structure of the heating means using the conductive nanofiber-based planar heating film according to an embodiment of the present disclosure.

FIG. 3 is a perspective view schematically illustrating an unfolded structure of the heating means using the conductive nanofiber-based planar heating film according to an embodiment of the present disclosure.

FIG. 4 is a longitudinal cross-sectional view schematically illustrating the structure of the planar heating film constituting the heating means using the conductive nanofiber-based planar heating film according to an embodiment of the present disclosure.

FIG. 5 is a diagram illustrating a first example of a path forming member constituting the heating means using the conductive nanofiber-based planar heating film according to an embodiment of the present disclosure.

FIG. 6 is a diagram illustrating a second example of a path forming member constituting the heating means using the conductive nanofiber-based planar heating film according to an embodiment of the present disclosure.

FIG. 7 is a diagram illustrating a third example of a path forming member constituting the heating means using the conductive nanofiber-based planar heating film according to an embodiment of the present disclosure.

FIG. 8 is a perspective view schematically illustrating a modification of the heating means using the conductive nanofiber-based planar heating film according to an embodiment of the present disclosure.

FIG. 9 is a side view schematically illustrating the modification of the heating means using the conductive nanofiber-based planar heating film according to an embodiment of the present disclosure.

FIG. 10 is a perspective view schematically illustrating an unfolded structure of the modification of the heating means using the conductive nanofiber-based planar heating film according to an embodiment of the present disclosure.

### DETAILED DESCRIPTION

Hereinafter, preferred embodiments of the present disclosure will be described in detail with reference to the accompanying drawings, so that those of ordinary skill in the art can easily carry out the present disclosure.

In describing the embodiments, descriptions of technologies that are well known in the technical field to which the present disclosure belongs and are not directly related to the present disclosure will be omitted. By omitting unnecessary description, the present disclosure may be described more clearly without obscuring the gist of the present disclosure.

For the same reason, some elements in the accompanying drawings are exaggerated, omitted, or schematically illustrated. Also, the size of each element does not entirely reflect the actual size. The same reference numerals are assigned to the same or corresponding elements in the drawings.

In addition, it will be understood that the expressions and terms as used herein with respect to device or element orientation (e.g., “front,” “back,” “up,” “down,” “top,” “bottom,” “left,” “right,” “lateral,” etc.) are only used to simplify the description of the present disclosure and do not necessarily indicate or imply that the relevant device or element should have a particular direction.

Hereinafter, the present disclosure will be described with reference to the drawings for explaining a heating means using a conductive nanofiber-based planar heating film 100 according to an embodiment of the present disclosure.

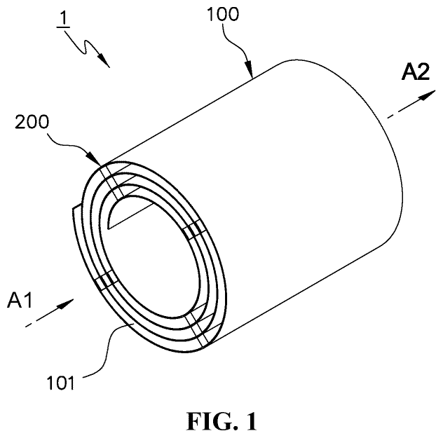

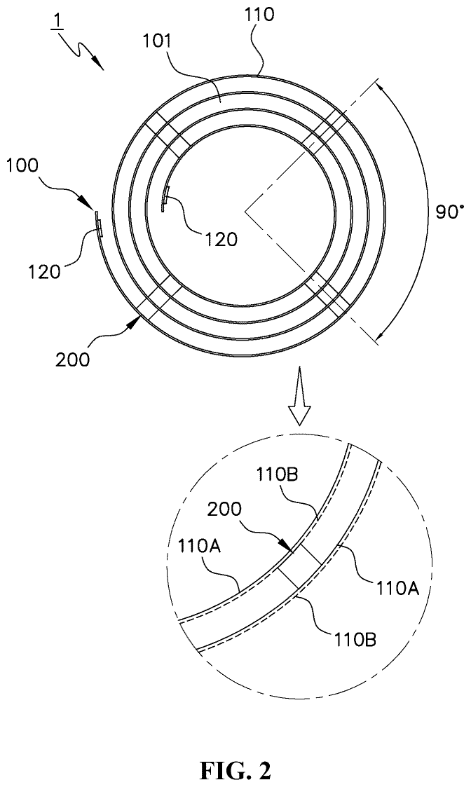

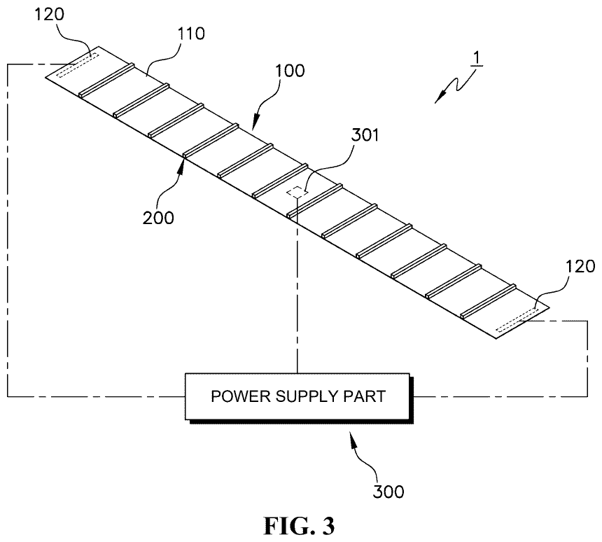

FIG. 1 is a perspective view schematically illustrating a structure of a heating means 1 using a conductive nanofiber-based planar heating film 100 according to an embodiment of the present disclosure, FIG. 2 is a front view schematically illustrating the structure of the heating means 1 using the conductive nanofiber-based planar heating film 100 according to an embodiment of the present disclosure, and FIG. 3 is a perspective view schematically illustrating an unfolded structure of the heating means 1 using the conductive nanofiber-based planar heating film 100 according to an embodiment of the present disclosure.

As illustrated in FIGS. 1 to 3, the heating means 1 using the conductive nanofiber-based planar heating film 100 according to an embodiment of the present disclosure may be configured to include the planar heating film 100, a plurality of path forming members 200, and a power supply part 300.

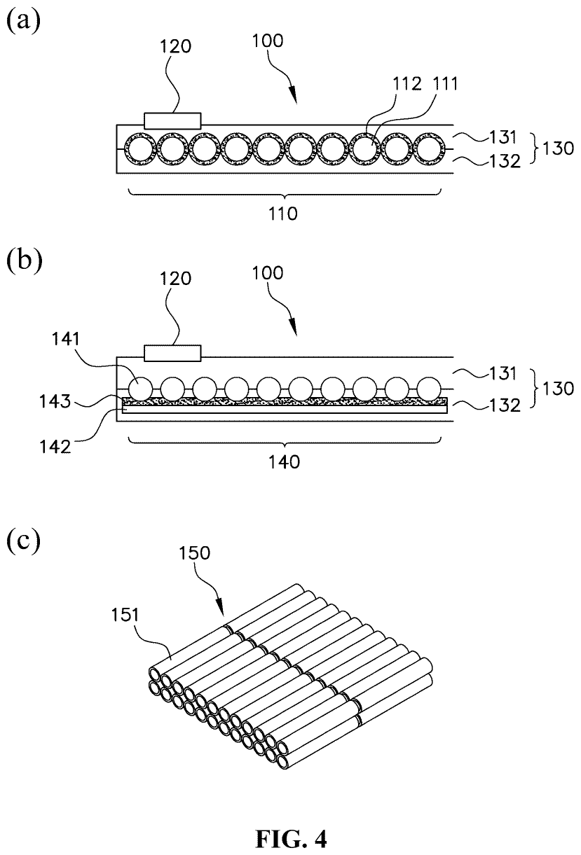

As illustrated in FIG. 3, the planar heating film 100 has a flexible material and may be formed to be long with a constant width. As illustrated in FIGS. 2 and 3, the planar heating film 100 may be configured to include a heating film 110 and an electrode part 120. A specific structure of the planar heating film 100 is described in detail below with reference to FIG. 4.

The plurality of path forming members 200 may be attached to a first surface of the planar heating film 100 (in the example of FIG. 3, the upper surface of the planar heating film 100) at predefined positions along the longitudinal direction of the planar heating film 100. That is, as illustrated in FIG. 3, the plurality of path forming members 200 are formed to be long with a length corresponding to a width of the planar heating film 100 and may be attached to predefined positions along the longitudinal direction of the planar heating film 100.

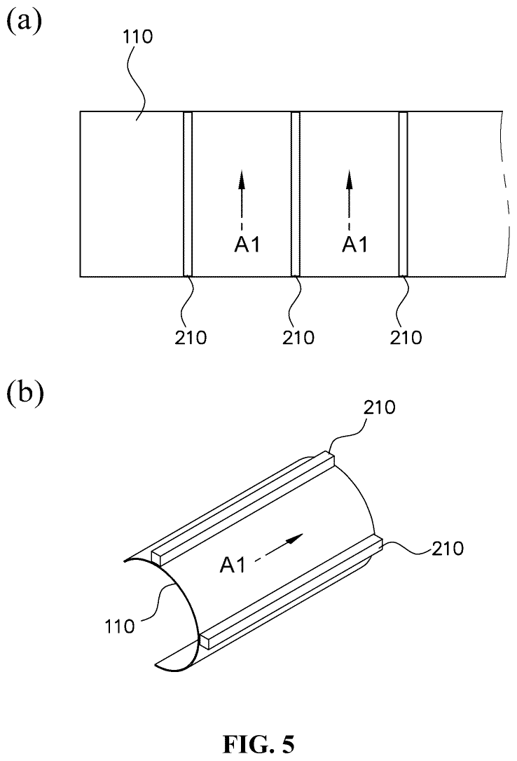

Preferably, each of the path forming members 200 may use a flexible metallic wire formed to be long along the width direction of the planar heating film 100 so as to form a path through which air flows. A specific shape of the path forming member 200 is described in detail below with reference to FIGS. 5 to 7.

The power supply part 300 may supply power to the planar heating film (100). As illustrated in FIGS. 2 and 3, the power supply part 300 may supply power to a pair of electrode parts 120 provided at both ends of the heating film 110 constituting the planar heating film 100. At this time, the power supply part 300 may control electric current applied to the electrode part 120 of the heating film 110 according to a temperature measurement value measured by a temperature sensor 301 provided in the heating film 110, thereby maintaining a temperature suitable for an air heating process.

Preferably, as illustrated in FIGS. 1 and 2, the planar heating film 100 constituting the heating means 1 using the conductive nanofiber-based planar heating film 100 according to an embodiment of the present disclosure is made of conductive nanofibers, and a space 101 through which air passes may be formed therein in a state of being spirally rolled along the longitudinal direction. That is, the planar heating film 100 may heat air A1 introduced from one side in the width direction while passing through an internal space 10, and may discharge heated air A2 heated to a desired temperature A2 through the other side in the width direction.

In addition, as illustrated in FIG. 2, the plurality of path forming members 200 may support a first surface 110A (a solid line) and a second surface 110B (a dashed line) adjacent to each other by coming into contact with the second surface 110B of the planar heating film 100 while the planar heating film 100 is spirally rolled, and may form a path (air flow) for air that is introduced from one side of the planar heating film 100 in the width direction and discharged to the other side of the planar heating film 100 in the width direction.

That is, the plurality of path forming members 200 may maintain a gap between the first surface 110A and the second surface 110B of the spirally rolled heating film 110 so that the first surface 110A and the second surface 110B adjacent to each other do not come into contact with each other and disturb the flow of air, and may also be formed to be long along the width direction of the heating film 110 to form a path through which air flows.

FIGS. 2 and 3 illustrate an example in which twelve path forming members 200 are provided along the longitudinal direction of the heating film 110 and three path forming members 200 are arranged at approximately 90-degree intervals in a state of being stacked along the radial outer direction of the spirally rolled heating film 110. However, the present disclosure is not limited thereto, and the number, arrangement form, arrangement interval, etc. of the path forming members 200 may be changed at any time by those of ordinary skill in the art.

Hereinafter, the structure of the planar heating film 100 constituting the heating means 1 using the conductive nanofiber-based planar heating film 100 according to an embodiment of the present disclosure is described in detail with reference to FIG. 4.

FIG. 4 is a longitudinal cross-sectional view schematically illustrating the structure of the planar heating film 100 constituting the heating means 1 using the conductive nanofiber-based planar heating film 100 according to an embodiment of the present disclosure.

As illustrated in FIG. 4, the planar heating film 100 constituting the heating means 1 using the conductive nanofiber-based planar heating film 100 according to an embodiment of the present disclosure may include a heating film 110 having a thin film shape and made of conductive nanofibers, and electrode parts 120 provided on both sides of the heating film 110 and electrically connected to a power supply part 300 to apply, to the heating film 110, electric current supplied from the power supply part 300.

Preferably, as illustrated in (a) and (b) of FIG. 4, the heating film 110 constituting the planar heating film 100 of the heating means 1 using the conductive nanofiber-based planar heating film 100 according to an embodiment of the present disclosure may be formed as at least one layer in which a plurality of nanofibers 111 are arranged in series and/or in parallel.

For example, as illustrated in (a) of FIG. 4, the heating film 110 may be formed as a single layer in which a plurality of nanofibers 111 coated with a conductive metal 112 are arranged in parallel along the longitudinal direction of the heating film 110. That is, each of the nanofibers 111 may be coated with the conductive metal 112, such as copper, silver (silver nanoparticles), nickel, or aluminum, and the nanofibers 111 coated with the conductive metal 112 may be arranged in parallel so as to be adjacent to each other, thereby forming the thin film-shaped heating film 110 as a whole.

Preferably, each of the nanofibers 111 may be manufactured by an electrospinning method or a microfluidic technology, and the conductive metal 112 may be coated on the outer circumferential surface of the nanofiber 111 by an electroless plating method. At this time, the nanofibers 111 may be manufactured to have a thickness of about 10 nm to about 2,000 nm.

As another example, as illustrated in (b) of FIG. 4, a heating film 140 may be formed as a single layer in which a plurality of nanofibers 141 are arranged in parallel along the longitudinal direction of the heating film 140 on a carbon ink layer 143 applied to one surface of a polyethylene terephthalate (PET) film 142. Similarly, each of the nanofibers 141 may be manufactured by an electrospinning method or a microfluidic technology.

Meanwhile, as illustrated in (a) and (b) of FIG. 4, the planar heating film 100 constituting the heating means 1 using the conductive nanofiber-based planar heating film 100 according to an embodiment of the present disclosure may further include a coating part 130.

Preferably, the coating part 130 may be formed on both surfaces (the upper and lower surfaces in the example of FIG. 4) of the heating films 110 and 140 and may be coated by a laminating method. That is, as illustrated in (a) and (b) of FIG. 4, the coating part 130 may include a first laminating film 131 coated on the upper surfaces of the heating films 110 and 140 and a second laminating film 132 coated on the lower surface of the heating film 110. Accordingly, the coating part 130 may maintain the thin film-shaped heating films 110 and 140 more firmly and stably. Although not illustrated in detail, the coating part 130 may coat the heating films 110 and 140 and the electrode part 120 together in a state where the electrode parts 120 are arranged on both sides of the heating films 110 and 140.

Meanwhile, (a) and (b) of FIG. 4 illustrate an example in which the plurality of nanofibers 111 and 141 constituting the heating film 110 are formed as a single layer arranged in parallel along the longitudinal direction (the left-and-right direction in the examples of (a) and (b) of FIG. 4) of the heating film 110 in a state of being formed to be long along the width direction of the heating film, but the present disclosure is not limited thereto, and the arrangement shape, arrangement direction, etc. of the heating film 110 may be changed at any time by those of ordinary skill in the art.

(c) of FIG. 4 illustrates an example in which a plurality of nanofibers 151 constituting a heating film 150 are formed as two layers arranged in series in two rows along the width direction of the heating film 150 in a state of being formed to be long along the width direction (the front-and-back direction in the example of (c) of FIG. 4) of the heating film 150 and arranged in parallel in twelve columns along the longitudinal direction (in the left-and-right direction in the example of (c) of FIG. 4) of the heating film 150.

At this time, it is preferable that the nanofibers 151 have a thickness of about 10 nm to about 2,000 nm, and a gap between the adjacent nanofibers 151 is 10 nm or more.

Accordingly, when the heating film 150 is formed as a plurality of layers by connecting the plurality of nanofibers 151 in series and in parallel, there is an advantage in which an air heating speed and area is freely controlled.

Hereinafter, the shape of the path forming member 200 constituting the heating means 1 using the conductive nanofiber-based planar heating film 100 according to an embodiment of the present disclosure is described in detail with reference to FIGS. 5 to 7.

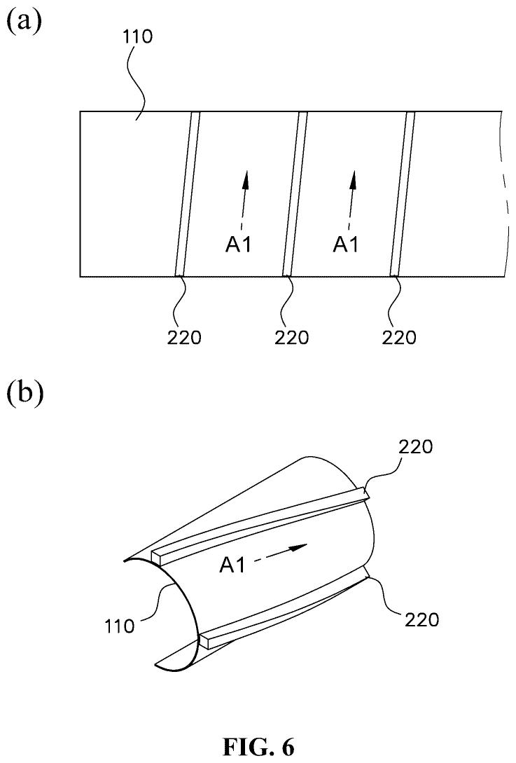

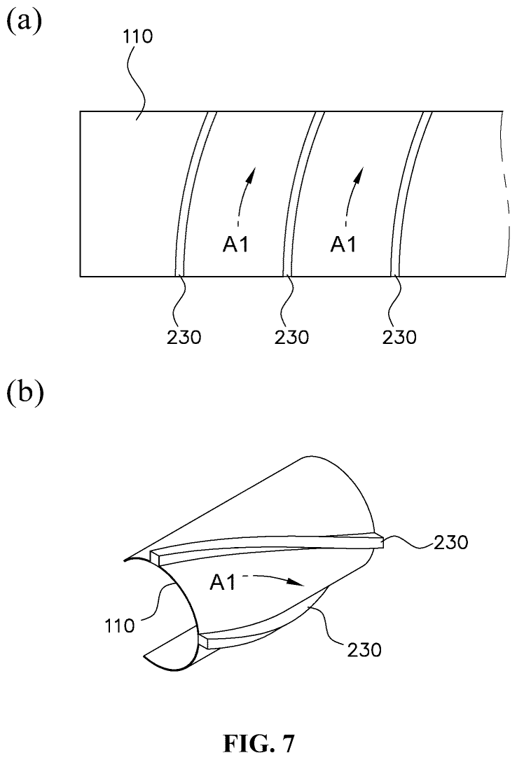

FIG. 5 is a diagram illustrating a first example of a path forming member constituting the heating means using the conductive nanofiber-based planar heating film 100 according to an embodiment of the present disclosure, FIG. 6 is a diagram illustrating a second example of a path forming member constituting the heating means using the conductive nanofiber-based planar heating film 100 according to an embodiment of the present disclosure, and FIG. 7 is a diagram illustrating a third example of a path forming member constituting the heating means using the conductive nanofiber-based planar heating film 100 according to an embodiment of the present disclosure.

(a) of FIG. 5, (a) of FIG. 6, and (a) FIG. 7 are plan views illustrating the shape of path forming members 210, 220, and 230 attached to the heating film 110, and (b) of FIG. 5, (b) FIG. 6, and (b) of FIG. 7 are perspective views illustrating the shape of the path forming members 210, 220, and 230 attached to the heating film 110.

As an example (a first example), as illustrated in (a) and (b) of FIG. 5, the path forming member 210 may be made of a flexible metallic wire and may be formed to be long along the width direction of the planar heating film 100. That is, the path forming member 210 illustrated in (a) and (b) of FIG. 5 may be formed to be long along the width direction of the heating film 110 so as to be perpendicular to the longitudinal direction of the heating film 110.

Accordingly, the vertical path forming member 210 illustrated in (a) and (b) of FIG. 5 may form a straight path so that air introduced from one side of the heating film 110 in the width direction (the lower side in the example of (a) of FIG. 5) is discharged to the other side of the heating film 110 in the width direction (the upper side in the example of (a) of FIG. 5) without changing the path.

As another example (a second example), as illustrated in (a) and (b) of FIG. 6, the path forming member 220 may be made of a flexible metallic wire and may be formed to be long and inclined along the width direction of the planar heating film 100. That is, the path forming member 220 illustrated in (a) and (b) of FIG. 6 may be formed to be long along the width direction of the heating film 110 at a certain angle with respect to the longitudinal direction or the width direction of the heating film 110.

Accordingly, the inclined path forming member 220 illustrated in (a) and (b) of FIG. 6 may form a straight path so that air introduced from one side of the heating film 110 in the width direction (the lower side in the example of (a) of FIG. 6) is discharged to the other side of the heating film 110 in the width direction (the upper side in the example of (a) of FIG. 6) at a certain angle along the first surface of the spirally rolled heating film 110.

As another example (a third example), as illustrated in (a) and (b) of FIG. 7, the path forming member 230 may be made of a flexible metallic wire and may be formed to be long in a spiral shape along the width direction of the planar heating film 100. That is, the path forming member 230 illustrated in (a) and (b) of FIG. 7 may be formed to be long in a spiral shape, like a screw, on the first surface of the heating film 110 along the width direction of the heating film 110.

Accordingly, the spiral path forming member 230 illustrated in (a) and (b) of FIG. 7 may form a curved path so that air introduced from one side of the heating film 110 in the width direction (the lower side in the example of (a) of FIG. 7) is discharged to the other side of the heating film 110 in the width direction (the upper side in the example of (a) of FIG. 7) while forming a small eddy along the first surface of the spirally rolled heating film 110. That is, the spiral path forming member 230 illustrated in (a) and (b) of FIG. 7 may increase the time for which air remains in the internal space 101 of the spirally rolled heating film 110, compared to the inclined path forming member 230 illustrated in (a) and (b) of FIG. 6.

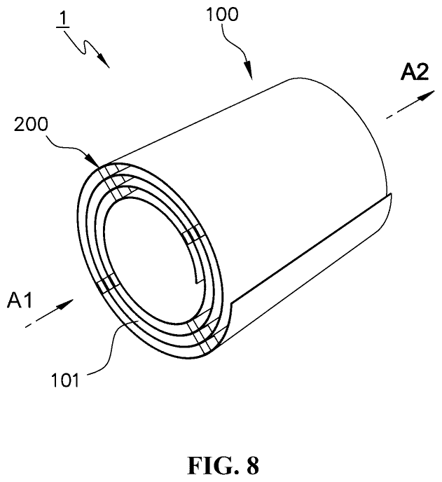

Hereinafter, a modification of the heating means 1 using the conductive nanofiber-based planar heating film 100 according to an embodiment of the present disclosure is described with reference to FIGS. 8 to 10. For convenience of explanation, a description of the same structures as those of the embodiments illustrated in FIGS. 1 to 7 is omitted and only the differences are mainly described below.

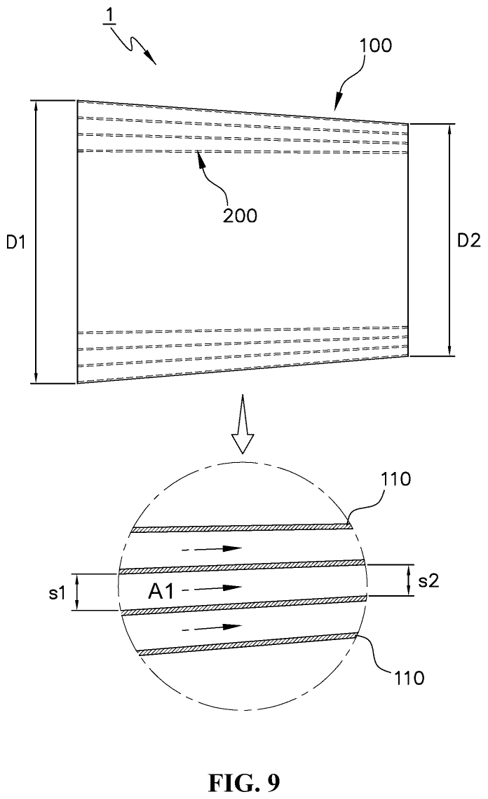

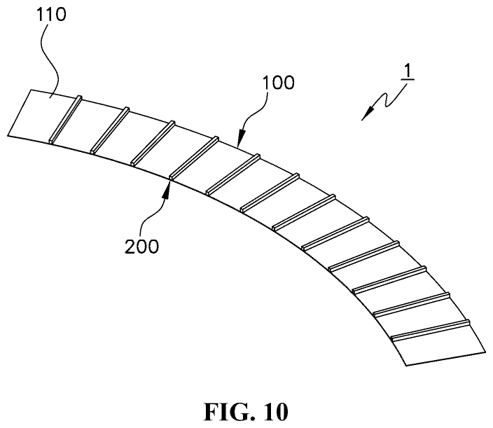

FIG. 8 is a perspective view schematically illustrating a modification of a heating means 1 using a conductive nanofiber-based planar heating film 100 according to an embodiment of the present disclosure, FIG. 9 is a side view schematically illustrating the modification of the heating means 1 using the conductive nanofiber-based planar heating film 100 according to an embodiment of the present disclosure, and FIG. 10 is a perspective view schematically illustrating an unfolded structure of the modification of the heating means 1 using the conductive nanofiber-based planar heating film 100 according to an embodiment of the present disclosure.

The modification of the heating means 1 using the conductive nanofiber-based heating film 100 illustrated in FIGS. 8 to 10, according to an embodiment of the present disclosure, may have a truncated conical shape that is spirally rolled so that the area of the other side through which air is discharged is narrower than the area of one side into which air is introduced, unlike the embodiments illustrated in FIGS. 1 to 7.

That is, the planar heating film 100 illustrated in FIGS. 8 to 10 differs from the planar heating film 100 illustrated in FIGS. 1 to 7, in that the planar heating film 100 illustrated in FIGS. 1 to 7 has a cylindrical shape with a constant cross-sectional area along the path through which air flows in a spirally rolled state as a whole, but the planar heating film 100 illustrated in FIGS. 8 to 10 has a truncated conical shape with a gradually decreasing cross-sectional area along the path through which air flows in a spirally rolled state as a whole.

As illustrated in FIGS. 9 and 10, the heating film 110 has a fan shape with one side and the other side having different radii in a state of being unfolded, and a diameter D1 of one side (the left side in the example of FIG. 9) of the heating film 110 in the width direction through which air is introduced in a state of being spirally rolled may be formed to be greater than a diameter D2 of the other side (the right side in the example of FIG. 9) of the heating film 110 in the width direction through which air is discharged.

Accordingly, as illustrated in FIG. 9, a gap between the first surface and the second surface of the spirally rolled heating film 110 gradually decreases along the path through which air flows (in the example of FIG. 9, a gap decreases from s1 to s2 at a certain section). As a result, the flow rate of air discharged from the other side of the heating film 110 in the width direction (the right side in the example of FIG. 9) is less than the flow rate of air introduced into one side of the heating film 110 in the width direction (the left side in the example of FIG. 9). Therefore, compared to the heating film 110 illustrated in FIGS. 1 to 7, the time for which air remains in the internal space 101 of the spirally rolled heating film 110 is increased, and thus, heat exchange with the air may be performed for a longer period of time.

As such, the heating means 1 using the conductive nanofiber-based planar heating film 100 according to an embodiment of the present disclosure is configured to form the space 101 through which air passes by spirally rolling the planar heating film 100 and to form an air path in a state where a plurality of path forming members 200 attached to the first surface of the planar heating film 100 support the adjacent first and second surfaces of the spirally rolled planar heating film 100. Therefore, a more simplified and miniaturized structure may improve heat transfer efficiency for air without disturbing air flow, and thus, the time to heat air to a desired temperature may be significantly shortened.

In addition, the heating means 1 using the conductive nanofiber-based planar heating film 100 according to an embodiment of the present disclosure configures the planar heating film 100 by using the flexible heating film 110 manufactured by arranging the plurality of nanofibers in parallel. Therefore, the manufacturing cost may be reduced due to the simpler structure and manufacturing process, and the overall energy efficiency may be increased because heat may be generated quickly up to a desired temperature.

In addition, the heating means 1 using the conductive nanofiber-based planar heating film 100 according to an embodiment of the present disclosure configures the planar heating film 100 by forming the coating part through laminating on both surfaces of the heating film 110 in which the plurality of nanofibers are arranged in parallel. Therefore, the structure of the thin and flexible heating film 110 may be maintained more firmly and stably.

Furthermore, the heating means 1 using the conductive nanofiber-based planar heating film 100 according to an embodiment of the present disclosure forms the plurality of path forming members 200 attached to the first surface of the planar heating film 100 so as to have an inclination along the width direction of the planar heating film 100 or have a spiral shape. Therefore, the air flow in the space 101 through which air passes may be controlled and the time for which the heated air remains may be increased, and thus, heat transfer efficiency for air may be improved.

Moreover, the heating means 1 using the conductive nanofiber-based heating film 100 according to an embodiment of the present disclosure configures the spirally rolled planar heating film 100 to have a truncated conical shape so that the area of the other side from which air is discharged is narrower than the area of one side into which air is introduced. Since the time for which the heated air remains in the space 101 through which air passes may be increased, and thus, heat transfer efficiency for air may be improved.

According to the heating means using the conductive nanofiber-based planar heating film according to an embodiment of the present disclosure, the planar heating film is spirally rolled to form the space through which air passes, and the plurality of path forming members attached to the first surface of the planar heating film are configured to form an air path while supporting the adjacent first and second surfaces of the spirally rolled planar heating film. Therefore, heat transfer efficiency for air may be improved without disturbing the air flow with a more simplified and miniaturized structure, and thus, an air heating time to a desired temperature may be significantly shortened.

In addition, according to the heating means using the conductive nanofiber-based planar heating film according to an embodiment of the present disclosure, the planar heating film is configured by using the flexible heating film manufactured by arranging the plurality of nanofibers in parallel. Therefore, the manufacturing cost may be reduced due to the simpler structure and manufacturing process, and the overall energy efficiency may be increased because heat may be generated quickly up to a desired temperature.

In addition, according to the heating means using the conductive nanofiber-based planar heating film according to an embodiment of the present disclosure, the planar heating film is configured by forming the coating part through laminating on both surfaces of the heating film in which the plurality of nanofibers are arranged in parallel. Therefore, the structure of the thin and flexible heating film may be maintained more firmly and stably.

Furthermore, according to the heating means using the conductive nanofiber-based planar heating film according to an embodiment of the present disclosure, the plurality of path forming members attached to the first surface of the planar heating film are formed to have an inclination along the width direction of the planar heating film or are formed in a spiral shape. Therefore, the air flow in the space through which air passes may be controlled and the time for which the heated air remains may be increased, and thus, heat transfer efficiency for air may be improved.

Moreover, according to the heating means using the conductive nanofiber-based heating film according to an embodiment of the present disclosure, the spirally rolled planar heating film is configured to have a truncated conical shape so that the area of the other side from which air is discharged is narrower than the area of one side into which air is introduced. Since the time for which the heated air remains in the space through which air passes may be increased, and thus, heat transfer efficiency for air may be improved.

The effects of the present disclosure are not limited to those described above, and other effects that are not described herein will be clearly understood from the description of the claims by those of ordinary skill in the art.

Meanwhile, the present specification and drawings disclose preferred embodiments of the present disclosure. Although specific terms are used, these terms are used only in a general sense to easily explain the technical concept of the present disclosure and help understanding of the present disclosure and are not intended to limit the scope of the present disclosure. In addition to the embodiments disclosed herein, it will be apparent to those of ordinary skill in the art that other modifications based on the technical idea of the present disclosure are possible.

### LIST OF REFERENCE NUMERALS FOR MAJOR ELEMENTS

1: heating means using conductive nanofiber-based planar heating film
100: planar heating film
110: heating film
111: nanofiber
112: conductive metal
120: electrode part
130: coating part
131: first laminating film
132: second laminating film
140: heating film
141: nanofiber
142: PET film
143: carbon ink layer
200: path forming member
210: vertical path forming member
220: inclined path forming member
230: spiral path forming member
300: power supply part
301: temperature sensor

What is claimed is:

1. A heating means using a conductive nanofiber-based planar heating film, the heating means comprising:
a planar heating film made of conductive nanofibers;
a plurality of path forming members attached to a first surface of the planar heating film at predefined positions along a longitudinal direction of the planar heating film; and
a power supply part that supplies power to the planar heating film,
wherein the planar heating film forms a space through which air passes in a state of being spirally rolled along the longitudinal direction, and
the plurality of path forming members support the first surface and a second surfaces adjacent to each other by coming into contact with the second surface of the planar heating film in a state where the planar heating film is spirally rolled, and form a path for air introduced from one side of the planar heating film in the width direction and discharged to another side of the planar heating film in the width direction.

2. The heating means of claim 1, wherein the planar heating film comprises:
a heating film formed as at least one layer in which a plurality of nanofibers coated with a conductive metal are arranged in series and/or in parallel; and
an electrode part provided on both sides of the heating film and applying electric current supplied from the power supply part to the heating film.

3. The heating means of claim 2, wherein the planar heating film further comprises a coating part formed on both surfaces of the heating film and coated by a laminating method.

4. The heating means of claim 1, wherein the planar heating film comprises:
a heating film formed by at least one layer in which a plurality of nanofibers are arranged in series and/or in parallel on a carbon ink layer applied to one surface of a polyethylene terephthalate (PET) film; and
an electrode part provided on both sides of the heating film and applying electric current supplied from the power supply part to the heating film.

5. The heating means of claim 4, wherein the planar heating film further comprises a coating part formed on both surfaces of the heating film and coated by a laminating method.

5. The heating means of claim 1, wherein the planar heating film has a truncated conical shape that is spirally rolled so that an area of another side through which air is discharged is narrower than an area of one side into which air is introduced.

6. The heating means of claim 1, wherein each of the plurality of path forming members is formed of a metallic wire formed to be long along a width direction of the planar heating film.

7. The heating means of claim 1, wherein each of the plurality of path forming members is formed of a metallic wire formed to be long and inclined along a width direction of the planar heating film.

8. The heating means of claim 1, wherein each of the plurality of path forming members is formed of a metallic wire formed to be long in a spiral shape along a width direction of the planar heating film.
